(19) United States
(12) Patent Application Publication
(10) Pub. No.: US 2021/0153538 A1
(43) Pub. Date: May 27, 2021

(54) AUTOMATIC ALL-IN-ONE MACHINE FOR CLEARING, PEELING, AND CLEANING YAM

(71) Applicant: Binzhou University, Binzhou (CN)

(72) Inventors: Pengchuan LIU, Binzhou (CN); Jing LIU, Binzhou (CN); Jianmeng CAO, Binzhou (CN)

(21) Appl. No.: 17/134,288

(22) Filed: Dec. 26, 2020

Related U.S. Application Data
(63) Continuation of application No. PCT/CN2020/128936, filed on Nov. 16, 2020.

(30) Foreign Application Priority Data
Nov. 27, 2019 (CN) 201911181560.0

(51) Int. Cl. A23N 15/00; A23N 7/02; A23N 12/02; B26D 1/08

(52) U.S. Cl. CPC A23N 15/00; B26D 1/08; A23N 12/023; A23N 7/023

(57) ABSTRACT

Provided is an automatic all-in-one machine for clearing, peeling, and cleaning yams, including: a rack; a two-end removing mechanism arranged on the rack; a conveying mechanism arranged on the rack and arranged in coordination with a storage box of the two-end removing mechanism; a feeding mechanism arranged on the rack, an input end of the feeding mechanism being coordinated with and connected to an output end of the two-end removing mechanism; a peeling and cleaning mechanism arranged on the rack, the peeling and cleaning mechanism being arranged in coordination with and adjacent to the feeding mechanism; and a controller connected to the two-end removing mechanism, the conveying mechanism, the feeding mechanism, and the peeling and cleaning mechanism respectively. Through the technical solution of the present invention, yams with different thicknesses and lengths can be automatically removed at both ends, peeled, and cleaned, which reduces waste and makes peeled cleaning cleaner.

### CROSS-REFERENCE TO RELATED APPLICATIONS

This application is a continuation of International Application No. PCT/CN2020/128936 with a filling date of Nov. 16, 2020, designating the United states, now pending, and further claims to the benefit of priority from Chinese Application No. 201911181560.0 with a filing date of Nov. 27, 2019. The content of the aforementioned applications, including any intervening amendments thereto, are incorporated herein by reference.

### TECHNICAL FIELD

The present invention relates to the technical field of food processing machinery, and particularly to an automatic all-in-one machine for clearing, peeling, and cleaning yams.

### BACKGROUND

In related arts, during processing of yams, two ends thereof are generally removed manually, and then the yams are automatically peeled and cleaned by machinery, or the yams are directly automatically peeled and cleaned by machinery without removing the two ends, which has the following technical defects:

(1) Manual removal of the two ends is inefficient, making it difficult to achieve automatic processing of the yams.

(2) Processing quality of the yams is easily affected if the two ends are not removed.

(3) When the existing machinery is difficult to adapt to yams with different thicknesses during automatic peeling and cleaning, the peeled thickness is thicker, leading to a certain waste, and the cleaning degree of peeled cleaning is poor.

### SUMMARY OF THE INVENTION

The present invention aims to solve at least one of the technical problems existing in the prior art or related art.

To this end, an objective of the present invention is to provide an automatic all-in-one machine for clearing, peeling, and cleaning yams.

To achieve the above objective, a technical solution of the present invention provides an automatic all-in-one machine for clearing, peeling, and cleaning yams, including: a rack; a two-end removing mechanism arranged on the rack; a conveying mechanism arranged on the rack, the conveying mechanism being arranged in coordination with a storage box of the two-end removing mechanism and being used for conveying a yam into the storage box; a feeding mechanism arranged on the rack, an input end of the feeding mechanism being coordinated with and connected to an output end of the two-end removing mechanism, and the feeding mechanism being used for pushing the yams after two-end removal through the two-end removing mechanism; a peeling and cleaning mechanism arranged on the rack, the peeling and cleaning mechanism being arranged in coordination with and adjacent to the feeding mechanism and being used for peeling and cleaning the yam pushed by the feeding mechanism; and a controller connected to the two-end removing mechanism, the conveying mechanism, the feeding mechanism, and the peeling and cleaning mechanism respectively.

In this solution, the two-end removing mechanism arranged on the rack can remove two ends of yams and can adapt to yams with different lengths, which implements an automatic operation of two-end removal for the yams and improves efficiency of the two-end removal. Moreover, the two-end removal for the yams is conducive to improving quality and a cleaning effect of the yams after treatment. The conveying mechanism arranged in coordination with the storage box of the two-end removing mechanism can convey yams into the storage box. The yams after two ends thereof are removed by the two-end removing mechanism is pushed in by the feeding mechanism, the yams are peeled and cleaned by the peeling and cleaning mechanism, the peeled thickness is thinner, the peeled cleaning effect is better, and the yams after treatment are cleaner. Through the controller connected to the two-end removing mechanism, the conveying mechanism, the feeding mechanism, and the peeling and cleaning mechanism respectively, automatic control over the two-end removing mechanism, the conveying mechanism, the feeding mechanism, and the peeling and cleaning mechanism are effectively achieved, thereby implementing an automated operation of clearing, peeling, and cleaning yams, improving an automation level of yam treatment, and improving quality and efficiency of yam treatment.

Specifically, a yam is placed on the conveying mechanism, the conveying mechanism drives the yam to enter into the storage box of the two-end removing mechanism, the two-end removing mechanism removes two ends of the yam, and then the feeding mechanism pushes the yam to be peeled and cleaned by the peeling and cleaning mechanism.

Preferably, the two-end removing mechanism includes: the storage box arranged adjacent to and in coordination with the conveying mechanism; an accommodating portion arranged adjacent to and in coordination with the storage box, a curved surface side of the accommodating portion being adjacent to the bottom of the storage box for accommodating the yams; a first push-rod motor and a push plate connected to and coordinated with each other, arranged on one semicircular opening side of the accommodating portion away from the feeding mechanism, the first push-rod motor being fixedly connected to the rack; a second push-rod motor and a vertical cutter connected to and coordinated with each other, arranged on one side of the push plate toward the accommodating portion, the vertical cutter being driven by the second push-rod motor to move up and down along a vertical direction to cut one end of the yam; a third push-rod motor and a baffle connected to and coordinated with each other, arranged on the other semicircular opening side of the accommodating portion adjacent to the feeding mechanism, the third push-rod motor being fixedly connected to the rack, and a first photoelectric sensor facing down being arranged in the top middle of the baffle; a fourth push-rod motor and a horizontal cutter connected to and coordinated with each other, arranged adjacent to the other semicircular opening side of the accommodating portion, the fourth push-rod motor being fixedly connected to the rack, the fourth push-rod motor pushing the horizontal cutter to move back and forth in a horizontal direction to cut away the other end of the yam, and the accommodating portion being provided with a cutter groove matching the horizontal cutter; a first yam end collection box arranged below a gap between the push plate and the semicircular opening side, the first yam end collection box being detachably connected to the rack; and a second yam end collection box arranged below a gap between the push plate and the semicircular opening side, the second yam end collection box being detachably connected to the rack.

In this solution, through the coordination between the accommodating portion and the storage box, yams can slide out of the storage box one by one and enter the accommodating portion for two-end removal. Through ingenious coordination of the first push-rod motor, the push plate, the third push-rod motor, the baffle, and the first photoelectric sensor, yams with different lengths can be pushed to corresponding positions, which is conducive to the removal of the two ends of the yams with different lengths. The two ends of the yams are cut away by the vertical cutter and the horizontal cutter. The removed ends of the yams can be collected through the first yam end collection box and the second yam end collection box, which, on the one hand, is conducive to waste recycling, and on the other hand, is conducive to cleaning and removal of the ends of the yams.

Preferably, the accommodating portion includes: two rotating semi-cylindrical panels welded opposite to each other on a first plain shaft, the first plain shaft being rotatably connected to the rack; a stepping motor connected to the first plain shaft, the stepping motor driving the first plain shaft to rotate to drive the rotating semi-cylindrical panels to rotate, and the stepping motor being fixedly connected to the rack; and a pressing plate fixedly connected to edges of the two rotating semi-cylindrical panels opposite to the conveying mechanism; and the two-end removing mechanism includes: an isolation plate arranged between the storage box and the accommodating portion, a horizontal end of the isolation plate being sleeved on a spring loop bar fixedly connected to the rack, a spring being sleeved on the spring loop bar, and a top end of the spring being in contact with the isolation plate; and a bottom surface of the storage box tilting downwards.

In this solution, through ingenious coordination of the stepping motor, the first plain shaft, the rotating semi-cylindrical panels, the pressing plate, and the isolation plate, yams can slide out of the storage box one by one and enter the rotating semi-cylindrical panels for two-end removal of the yams. It should be noted that the rotating semi-cylindrical panels may be rotating semi-cylindrical iron plates. The stepping motor stops after each rotation of 180 degrees. The stopping time of the stepping motor can be preset according to an actual production requirement.

Preferably, the two-end removing mechanism further includes: a support plate fixedly connected to a lower part of the push plate, the support plate being perpendicular to the push plate and extending toward the accommodating portion along the horizontal direction, a height of an extension section of the support plate from the push plate to the accommodating portion being lower than a bottom surface of the accommodating portion, and a horizontal length of the extension section being greater than a horizontal distance from the vertical cutter to the push plate; and a second photoelectric sensor fixedly connected to the rack and oriented toward the support plate.

In this solution, when the vertical cutter cuts away the ends of the yam, the support plate fixedly connected to a lower part of the push plate moves to the bottom surface of the rotating semi-cylindrical panel, which can prevent the cylindrical panel from shifting. Through the second photoelectric sensor, when resetting of the support plate is detected, the stepping motor can be started to drive the rotating semi-cylindrical panel to rotate, which further improves the efficiency of the two-end removal.

Specifically, the working process of the two-end removing mechanism is as follows: the stepping motor drives the rotating semi-cylindrical panel to rotate clockwise. With the rotation of the rotating semi-cylindrical panel, the pressing plate on the rotating semi-cylindrical panel comes into contact with a horizontal end of the isolation plate. With the continuous rotation of the rotating semi-cylindrical panel, the isolation plate moves down, and the yam in the storage box slides into the rotating semi-cylindrical panel. When the isolation plate is lower than the storage box, the stepper motor stops, that is, the stepper motor stops after rotating by 180 degrees clockwise. In this case, the push plate and the baffle are both tangent to the rotating semi-cylindrical panel. Then, the first push-rod motor drives the push plate to move forward. The push plate drives the yam inside the rotating semi-cylindrical panel to move forward, and at the same time drives the support plate to move forward to provide support at the bottom of the rotating semi-cylindrical panel, so as to prevent the rotating semi-cylindrical panel from moving when the vertical cutter cuts downward. When a front end of the yam hits the baffle, the first photoelectric sensor detects a signal and controls the first push-rod motor to stop, and the second push-rod motor drives the vertical cutter to move downward. At the same time, the fourth push-rod motor drives the horizontal cutter to move forward horizontally to cut off a small piece of two ends of the yam. The cutting length of the two ends of the yam is fixed. Upon completion of the cutting, the fourth push-rod motor drives the horizontal cutter to reset, the third push-rod motor drives the baffle to reset, and then the first push-rod motor drives the vertical cutter to push the yam to continuously move forward. The cut front end of the yam is pushed into the second yam end collection box, and then the yam is pushed into the feeding mechanism. When the yam is generally pushed into the feeding mechanism about 10 cm, the first push-rod motor drives the push plate back. On the return trip, the vertical cutter pulls a cut back end of the yam back and drops it into the first yam end collection box, the vertical cutter is reset, and the support plate is reset. When resetting of the support plate is detected by the second photoelectric sensor, the stepping motor continues to rotate by 180 degrees. During rotation of the stepping motor, the pressing plate on the rotating semi-cylindrical panel separates from the horizontal end of the isolation plate, the isolation plate rises. At the same time, a delay of 3 seconds is generated, when the second photoelectric sensor detects that the support plate is reset, and the conveying mechanism continues to work repeatedly, achieving that another yam falls into the storage box and the above working process continues to be repeated.

Preferably, the feeding mechanism includes: a first rolling wheel and a second plain shaft fixedly connected to each other, the first rolling wheel being sleeved on the second plain shaft, the second plain shaft being rotatably connected to the rack, and one end of the second plain shaft being connected to a feeding motor; a second rolling wheel and a third plain shaft fixedly connected to each other, the second rolling wheel being sleeved on the third plain shaft, one end of the third plain shaft being clamped in an plain shaft slot, the plain shaft slot being arranged on the rack, and one end of the third plain shaft clamped in the plain shaft slot being connected to the other end of the second plain shaft through a tensioning transmission mechanism; and a slider sleeved on the third plain shaft, the slider being clamped in a slider chute, the slider chute being provided on the rack, a position of the slider chute being in coordination with a position of the second roller, the slider being vertically connected to the rack through a first tension spring, and the second plain shaft passing through a bump at a position where the first tension spring is vertically connected to the rack, wherein the feeding motor drives the first rolling wheel and the second rolling wheel to rotate in reverse directions simultaneously, and the tensioning transmission mechanism includes: a first gear sleeved on the other end of the second plain shaft, the first gear being fixedly connected to the second plain shaft; a second gear and a third gear arranged in coordination, the second gear and the third gear being connected through a fourth plain shaft connected to the rack through a bearing, and the second gear engaging with the first gear; a fourth gear sleeved on one end of the third plain shaft, the fourth gear being fixedly connected to the third plain shaft; two fifth gears axisymmetric with respect to a connection line between the third gear and the fourth gear, the third gear, the fourth gear, and the two fifth gears being connected through a chain; two gear struts, the two fifth gears being mounted to one end of the two gear struts through bearings respectively, and the other end of the two gear struts being connected to the rack through a bidirectional bearing; a strut slot provided in a middle-upper part of the bidirectional bearing, the strut slot being fixedly connected to the rack and used for limiting a rotation angle of the gear strut; and two second tension springs with one end connected to one end of the two gear struts respectively, and the other end connected to an outer sidewall of the strut slot.

In this solution, the feeding motor drives the first rolling wheel and the second rolling wheel to rotate in reverse directions at the same time, which improves the feeding efficiency. The tensioning transmission mechanism, the first tension spring, the slider, and so on can adjust the distance between the first rolling wheel and the second rolling wheel, so as to adapt to feeding of yams with different thicknesses. The tensioning transmission mechanism achieves tensioning and transmission through the coordination of gears, chains, a second tension spring, and so on, and has a limit on a maximum opening angle, which not only ensures the feeding of yams with different thicknesses, but also reduces the occurrence of yam slipping and other phenomena caused by a too large opening angle.

Preferably, the peeling and cleaning mechanism includes: a ring plate fixed to the rack, an opening of the ring plate being oriented toward the feeding mechanism; a peeling knife component fixedly connected to the interior of the ring plate; an annular water pipe arranged on a peripheral side of the ring plate, the annular water pipe being connected to an external water supply device; a cleaning nozzle connected to the annular water pipe, the cleaning nozzle being oriented toward the peeling knife component; a waste water collection box arranged below the ring plate, the waste water collection box being detachably connected to the rack; and a waste water chute, the top of the waste water chute being connected to the bottom of the ring plate, and the bottom of the waste water chute being imported into the waste water collection box.

In this solution, the ring plate supports the peeling knife component and the annular water pipe. Peeled yams are cleaned through the cleaning nozzle. The water chute is conducive to the water slipping into the waste water collection box. Thus, peeling and cleaning operation of the yams are implemented.

The waste water collection box may be further provided with a sewage outlet to discharge waste water.

Preferably, there are two ring plates connected to each other, a plurality of peeling knife components are annularly arrayed in each of the ring plates, and positions of the peeling knife components in the two ring plates are staggered.

In this solution, two ring plates connected to each other are arranged, a plurality of peeling knife components are annularly arrayed in each of the ring plates, and positions of the peeling knife components in the two ring plates are staggered, so that the peeling of the yams is more comprehensive, cleaner, and more efficient. Preferably, 6 peeling knife components are arranged in each of the ring plates, the peeling knife components are annularly arrayed in the ring plates, included angles formed by every two adjacent peeling knife components are the same in front projections of the 12 peeling knife components in the two ring plates. The peeling knife component includes: spring boxes vertically fixed and connected to the ring plate, and three springs being uniformly arranged in each of the spring boxes; a spring pressing plate embedded in a port of the spring box toward the center of the ring plate; a peeling knife support rod fixedly connected to the spring pressing plate; and a peeling knife and a limit rolling wheel arranged on a lower end of the peeling knife support rod, a distance between the limit rolling wheel and the spring box being less than a distance between the peeling knife and the spring box, the peeling knife and the limit rolling wheel being arranged in front and back and adjacent to each other, and when the yam is pushed in, the yam first passing through the limit rolling wheel and then passing through the peeling knife.

In this solution, when ends of the yam enter the peeling and cleaning mechanism, the limit rolling wheel first contacts a surface of the yam, and the peeling knife support rod fixed to the spring pressing plate can make adaptive adjustment according to changes in yam thicknesses under the action of spring pressure. That is, after the limit rolling wheel measures the diameter of the yam, the peeling knife adjacent thereto peels the yam. Then, a second group of peeling knives arranged in a staggered manner remove, in a supplementary manner, the remaining surface after peeling by a first group of peeling knives. As the feeding mechanism continuously advances the yam, the two groups of peeling knife components can implement the continuous peeling of the whole yam.

It should be noted that the spring pressing plate moves back and forth while pressing the spring, and cannot slide out of the spring box. A peeling thickness can be controlled by adjusting a height difference between the limit rolling wheel and the peeling knife.

Preferably, the cleaning nozzle one-to-one corresponds to the peeling knife component.

In this solution, the one-to-one correspondence between the cleaning nozzle and the peeling knife component further improves the cleaning efficiency and cleanliness.

Preferably, the conveying mechanism includes: a conveying motor and rollers arranged in coordination, fixedly connected to the rack, the two rollers being arranged at intervals, and the conveying motor being connected to one of the rollers; a conveyor belt sleeved on the roller, the conveying motor driving the roller to rotate, so as to drive the conveyor belt for transmission, and the conveyor belt being arranged in coordination with the storage box to convey the yam into the storage box; a plurality of partitions arranged at intervals on the conveyor belt; and a third photoelectric sensor arranged on a lower side of the roller adjacent to the storage box, the third photoelectric sensor being oriented toward a bottom part of the conveyor belt, and a vertical distance between the third photoelectric sensor and the lowest surface of the conveyor belt being lower than the height of the partitions.

In this solution, the conveying motor, the roller, the conveyor belt, the plurality of partitions, the third photoelectric sensor, and so on are arranged in coordination to implement automatic conveying of yams, which controls that one yam is conveyed into the storage box of the two-end removing mechanism at a time, is conducive to two-end removal, peeling, cleaning, and other operations on the yams, and has a high automation degree of conveying and high conveying efficiency.

Specifically, a single yam is placed between two adjacent partitions, and the third photoelectric sensor controls a conveying distance of the conveyor by detecting the partitions on the conveyor belt. When the third photoelectric sensor detects a signal, it controls the stop of the conveyor belt upon a delay of 1 second, thus controlling forward conveying of one yam at a time. The conveyor belt is tilted to ensure that the yam slips into the storage box. Herein, controlling the conveyor belt to stop upon a delay of 1 second can effectively reduce the occurrence of self-locking of the third photoelectric sensor and the second photoelectric sensor.

Through the above technical solutions, the two-end removing mechanism, the conveying mechanism, the feeding mechanism, the peeling and cleaning mechanism, the controller, and so on are arranged to perform automatic two-end removal, peeling, cleaning, and other operations on yams with different thicknesses and lengths.

Through ingenious coordination between the stepping motor, the photoelectric sensors, and so on, the yams slip out one by one. Two ends of the yams with different lengths can be removed through the coordination of the photoelectric sensors, the push-rod motor, and the cutter. The tensioning transmission mechanism arranged in the feeding mechanism can achieve that a motor drives two rolling wheels to rotate in reverse directions simultaneously, and can achieve a change in the distance between the two rolling wheels according to yams with different thicknesses, so as to feed the yams with different thicknesses. The peeling knife and the limit rolling wheel are arranged in coordination to control the thickness of peeling, which reduces waste to some extent and makes peeled cleaning clearer and the quality of the yams after treatment better.

Some of the additional aspects and advantages of the present invention will be given in the following description, and some will become apparent from the description below or be known through the practice of the present invention.

### BRIEF DESCRIPTION OF DRAWINGS

The above and/or additional aspects and advantages of the present invention will become apparent and easily understood from the description of embodiments with reference to the accompanying drawings below. In the drawings,

FIG. 1 is a schematic structural diagram of an automatic all-in-one machine for clearing, peeling, and cleaning yams according to an embodiment of the present invention;

FIG. 2 is a schematic structural diagram of an automatic all-in-one machine for clearing, peeling, and cleaning yams according to an embodiment of the present invention;

FIG. 3 is a schematic structural diagram of an automatic all-in-one machine for clearing, peeling, and cleaning yams according to an embodiment of the present invention;

FIG. 4 is a top view of an automatic all-in-one machine for clearing, peeling, and cleaning yams according to an embodiment of the present invention;

FIG. 5 is a left view of an automatic all-in-one machine for clearing, peeling, and cleaning yams according to an embodiment of the present invention;

FIG. 6 is a schematic enlarged view of A in FIG. 2;

FIG. 7 is a schematic enlarged view of B in FIG. 2;

FIG. 8 is a schematic structural diagram of an isolation plate in FIG. 1;

FIG. 9 is a schematic structural diagram of a feeding mechanism in FIG. 1;

FIG. 10 is a schematic enlarged view of C in FIG. 9;

FIG. 11 is a schematic structural diagram of a peeling and cleaning mechanism in FIG. 1;

FIG. 12 is a front view of the peeling and cleaning mechanism in FIG. 11; and

FIG. 13 is a schematic structural diagram of a peeling knife component in FIG. 11.

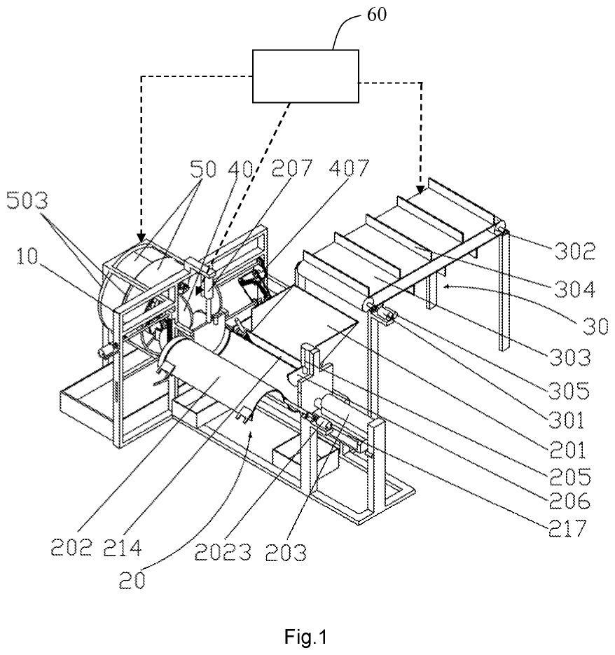

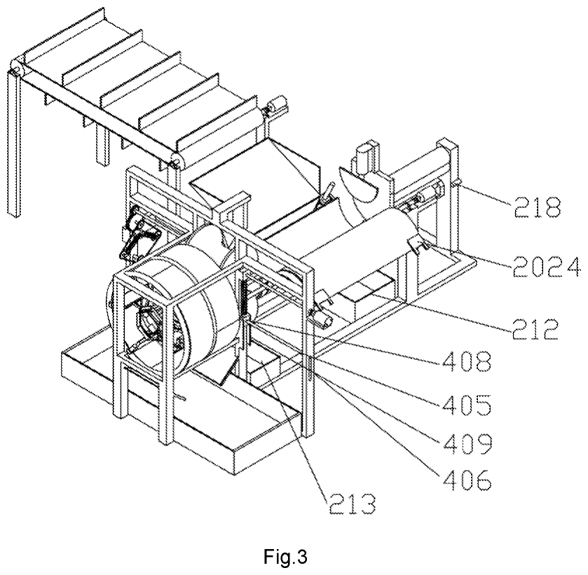

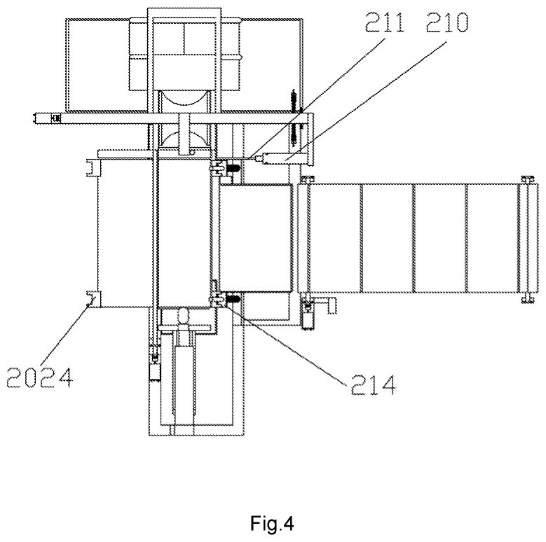

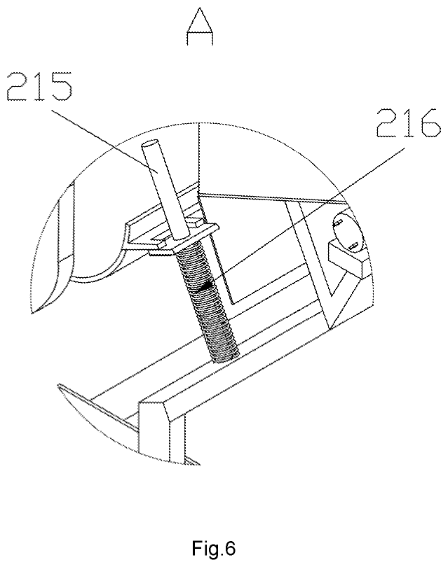

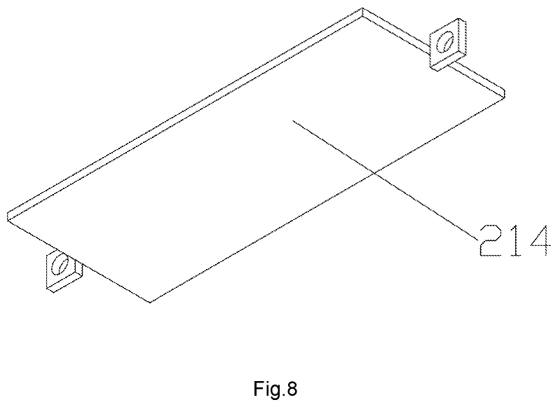

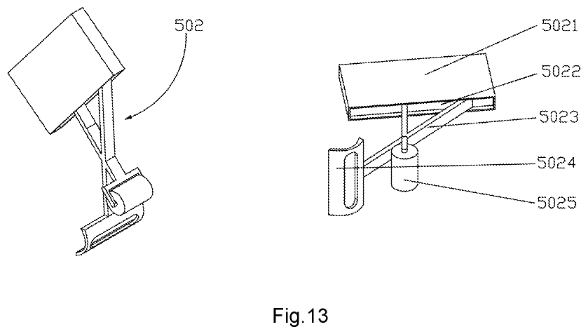

Correspondences between reference numerals and parts in FIG. 1 to FIG. 13 are as follows:

10 rack, 20 two-end removing mechanism, 201 storage box, 202 accommodating portion, 2021 rotating semi-cylindrical panel, 2022 first plain shaft, 2023 stepping motor, 2024 pressing plate, 203 first push-rod motor, 204 push plate, 205 second push-rod motor, 206 vertical cutter, 207 third push-rod motor, 208 baffle, 209 first photoelectric sensor, 210 fourth push-rod motor, 211 horizontal cutter, 212 first yam end collection box, 213 second yam end collection box, 214 isolation plate, 215 spring loop bar, 216 spring, 217 support plate, 218 second photoelectric sensor, 219 cutter groove, 30 conveying mechanism, 301 conveying motor, 302 roller, 303 conveyor belt, 304 partition, 305 third photoelectric sensor, 40 feeding mechanism, 401 first rolling wheel, 402 second plain shaft, 403 feeding motor, 404 second rolling wheel, 405 third plain shaft, 406 plain shaft slot, 407 tensioning transmission mechanism, 4071 first gear, 4072 second gear, 4073 third gear, 4074 fourth plain shaft, 4075 fourth gear, 4076 fifth gear, 4077 gear strut, 4078 bidirectional bearing, 4079 strut slot, 4081 second tension spring, 4082 chain, 408 slider, 409 slider chute, 410 first tension spring, 50 peeling and cleaning mechanism, 501 ring plate, 502 peeling knife component, 5021 spring box, 5022 spring pressing plate, 5023 peeling knife support rod, 5024 peeling knife, 5025 limit rolling wheel, 503 annular water pipe, 504 cleaning nozzle, 505 waste water collection box, 506 waste water chute, 60 controller.

### DETAILED DESCRIPTION OF EMBODIMENTS

In order to better understand the objectives, features, and advantages of the present invention, the present invention is described below in further detail with reference to the accompanying drawings and specific implementations. It should be noted that without a conflict, the embodiments of this application and the features in the embodiments may be combined with each other.

Many specific details are set forth in the following description to facilitate a full understanding of the present invention. However, the present invention may be implemented in other manners other than those described herein. Therefore, the protection scope of the present invention is not limited by the specific embodiments disclosed below.

An automatic all-in-one machine for clearing, peeling, and cleaning yams according to an embodiment of the present invention is specifically described below with reference to FIG. 1 to FIG. 13.

As shown in FIG. 1 to 5, an automatic all-in-one machine for clearing, peeling, and cleaning yams according to the embodiment of the invention includes: a rack 10; a two-end removing mechanism 20 arranged on the rack 10; a conveying mechanism 30 arranged on the rack 10, the conveying mechanism 30 being arranged in coordination with a storage box 201 of the two-end removing mechanism 20 and being used for conveying a yam into the storage box 201; a feeding mechanism 40 arranged on the rack 10, an input end of the feeding mechanism 40 being coordinated with and connected to an output end of the two-end removing mechanism 20, and the feeding mechanism 40 being used for pushing the yams after two-end removal through the two-end removing mechanism 20; a peeling and cleaning mechanism 50 arranged on the rack 10, the peeling and cleaning mechanism 50 being arranged in coordination with and adjacent to the feeding mechanism 40 and being used for peeling and cleaning the yam pushed by the feeding mechanism 40; and a controller connected to the two-end removing mechanism 20, the conveying mechanism 30, the feeding mechanism 40, and the peeling and cleaning mechanism 50 respectively.

In this embodiment, the two-end removing mechanism 20 arranged on the rack 10 can remove two ends of yams and can adapt to yams with different lengths, which implements an automatic operation of two-end removal for the yams and improves efficiency of the two-end removal. Moreover, the two-end removal for the yams is conducive to improving quality and a cleaning effect of the yams after treatment. The conveying mechanism 30 arranged in coordination with the storage box 201 of the two-end removing mechanism 20 can convey yams into the storage box 201. The yams after two ends thereof are removed by the two-end removing mechanism 20 is pushed in by the feeding mechanism 40, the yams are peeled and cleaned by the peeling and cleaning mechanism 50, the peeled thickness is thinner, the peeled cleaning effect is better, and the yams after treatment are cleaner. Through the controller connected to the two-end removing mechanism 20, the conveying mechanism 30, the feeding mechanism 40, and the peeling and cleaning mechanism 50 respectively, automatic control over the two-end removing mechanism 20, the conveying mechanism 30, the feeding mechanism 40, and the peeling and cleaning mechanism 50 are effectively achieved, thereby implementing an automated operation of clearing, peeling, and cleaning yams, improving an automation level of yam treatment, and improving quality and efficiency of yam treatment. Specifically, a yam is placed on the conveying mechanism 30, the conveying mechanism 30 drives the yam to enter into the storage box 201 of the two-end removing mechanism 20, the two-end removing mechanism 20 removes two ends of the yam, and then the feeding mechanism 40 pushes the yam to be peeled and cleaned by the peeling and cleaning mechanism 50.

As shown in FIG. 1 to 8, the two-end removing mechanism 20 includes: the storage box 201 arranged adjacent to and in coordination with the conveying mechanism 30; an accommodating portion 202 arranged adjacent to and in coordination with the storage box 201, a curved surface side of the accommodating portion 202 being adjacent to the bottom of the storage box 201 for accommodating the yams, so as to remove two ends of the yam; a first push-rod motor 203 and a push plate 204 connected to and coordinated with each other, arranged on one semicircular opening side of the accommodating portion 202 away from the feeding mechanism 40, the first push-rod motor 203 being fixedly connected to the rack 10; a second push-rod motor 205 and a vertical cutter 206 connected to and coordinated with each other, arranged on one side of the push plate 204 toward the accommodating portion 202, the vertical cutter 206 being driven by the second push-rod motor 205 to move up and down along a vertical direction to cut one end of the yam; a third push-rod motor 207 and a baffle 208 connected to and coordinated with each other, arranged on the other semicircular opening side of the accommodating portion 202 adjacent to the feeding mechanism 40, the third push-rod motor 207 being fixedly connected to the rack 10, and a first photoelectric sensor 209 facing down being arranged in the top middle of the baffle 208; a fourth push-rod motor 210 and a horizontal cutter 211 connected to and coordinated with each other, arranged adjacent to the other semicircular opening side of the accommodating portion 202, the fourth push-rod motor 210 being fixedly connected to the rack 10, the fourth push-rod motor 210 pushing the horizontal cutter 211 to move back and forth in a horizontal direction to cut away the other end of the yam, and the accommodating portion 202 being provided with a cutter groove 219 matching the horizontal cutter 211; a first yam end collection box 212 arranged below a gap between the push plate 204 and the semicircular opening side, the first yam end collection box 212 being detachably connected to the rack 10; and a second yam end collection box 213 arranged below a gap between the push plate 204 and the semicircular opening side, the second yam end collection box 213 being detachably connected to the rack 10.

In this embodiment, through the coordination between the accommodating portion 202 and the storage box 201, yams can slide out of the storage box 201 one by one and enter the accommodating portion 202 for two-end removal. Through ingenious coordination of the first push-rod motor 203, the push plate 204, the third push-rod motor 207, the baffle 208, and the first photoelectric sensor 209, two ends of yams with different lengths can be pushed to corresponding positions, which is conducive to the removal of the two ends of the yams with different lengths. The two ends of the yams are cut away by the second push-rod motor 205, the vertical cutter 206, the fourth push-rod motor 210, and the horizontal cutter 211. The removed ends of the yams can be collected through the first yam end collection box 212 and the second yam end collection box 213, which, on the one hand, is conducive to waste recycling, and on the other hand, is conducive to cleaning and removal of the ends of the yams.

As shown in FIG. 1 to 6 and FIG. 8, the accommodating portion 202 includes: two rotating semi-cylindrical panels 2021 welded opposite to each other on a first plain shaft 2022, the first plain shaft 2022 being rotatably connected to the rack 10; a stepping motor 2023 connected to the first plain shaft 2022, the stepping motor 2023 driving the first plain shaft 2022 to rotate to drive the rotating semi-cylindrical panels 2021 to rotate, and the stepping motor 2023 being fixedly connected to the rack 10; and a pressing plate 2024 fixedly connected to two edges of the two rotating semi-cylindrical panels 2021 opposite to the conveying mechanism 30; and the two-end removing mechanism 20 includes: an isolation plate 214 arranged between the storage box 201 and the accommodating portion 202, a horizontal end of the isolation plate 214 being sleeved on a spring loop bar 215 fixedly connected to the rack 10, a spring 216 being sleeved on the spring loop bar 215, and a top end of the spring 216 being in contact with the isolation plate 214; and a bottom surface of the storage box 201 tilting downwards.

In this embodiment, through ingenious coordination of the stepping motor 2023, the first plain shaft 2022, the rotating semi-cylindrical panels 2021, the pressing plate 2024, and the isolation plate 214, yams can slide out of the storage box 201 one by one and enter the rotating semi-cylindrical panels 2021 for two-end removal of the yams. It should be noted that the rotating semi-cylindrical panels 2021 may be rotating semi-cylindrical iron plates. The stepping motor 2023 stops after each rotation of 180 degrees. The stopping time of the stepping motor 2023 can be preset according to an actual production requirement.

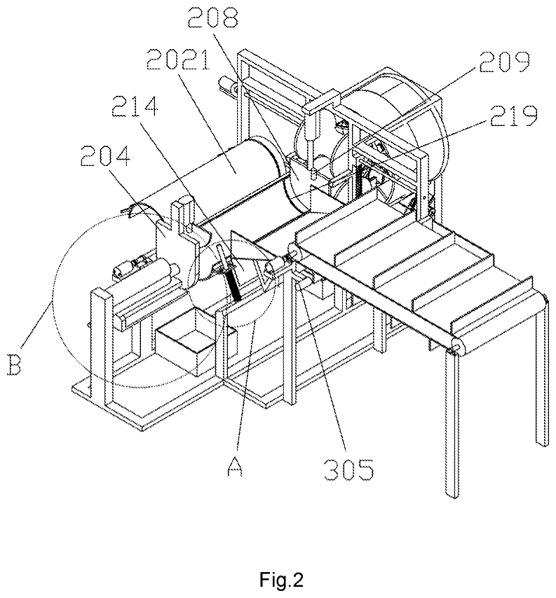

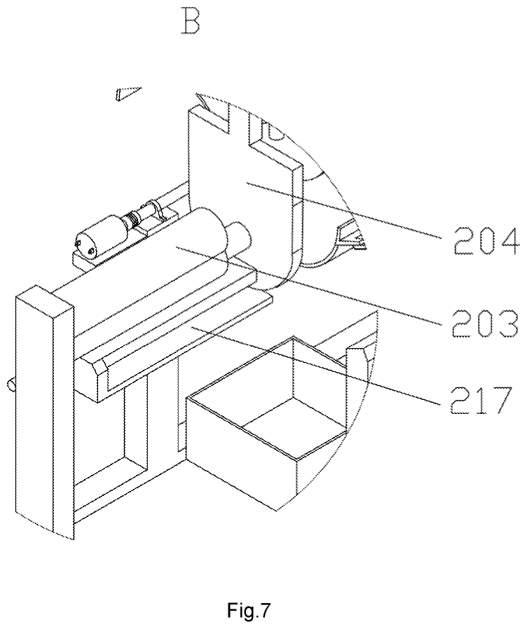

As shown in FIG. 2 and FIG. 7, the two-end removing mechanism 20 further includes: a support plate 217 fixedly connected to a lower part of the push plate 204, the support plate 217 being perpendicular to the push plate 204 and extending toward the accommodating portion 202 along the horizontal direction, a height of an extension section of the support plate 217 from the push plate 204 to the accommodating portion 202 being lower than a bottom surface of the accommodating portion 202, and a horizontal length of the extension section being greater than a horizontal distance from the vertical cutter 206 to the push plate 204; and a second photoelectric sensor 218 fixedly connected to the rack 10 and oriented toward the support plate 217.

In this embodiment, when the vertical cutter 206 cuts away the ends of the yam, the support plate 217 fixedly connected to a lower part of the push plate 204 moves to the bottom surface of the rotating semi-cylindrical panel 2021, which can prevent the rotating semi-cylindrical panel 2021 from shifting. Through the second photoelectric sensor 218, when resetting of the support plate 217 is detected, the stepping motor 2023 can be started to drive the rotating semi-cylindrical panel 2021 to rotate, which further improves the efficiency of the two-end removal.

Specifically, the working process of the two-end removing mechanism 20 is as follows: the stepping motor 2023 drives the rotating semi-cylindrical panel 2021 to rotate clockwise. With the rotation of the rotating semi-cylindrical panel 2021, the pressing plate 2024 on the rotating semi-cylindrical panel 2021 comes into contact with a horizontal end of the isolation plate 214. With the continuous rotation of the rotating semi-cylindrical panel 2021, the isolation plate 214 moves down, and the yam in the storage box 201 slides into the rotating semi-cylindrical panel 2021. When the isolation plate 214 is lower than the storage box 201, the stepper motor stops 2023, that is, the stepper motor 2023 stops after rotating by 180 degrees clockwise. In this case, the push plate 204 and the baffle 208 are both tangent to the rotating semi-cylindrical panel 2021. Then, the first push-rod motor 203 drives the push plate 204 to move forward. The push plate 204 drives the yam inside the rotating semi-cylindrical panel 2021 to move forward, and at the same time drives the support plate 217 to move forward to provide support at the bottom of the rotating semi-cylindrical panel 2021, so as to prevent the rotating semi-cylindrical panel 2021 from moving when the vertical cutter 206 cuts downward. When a front end of the yam hits the baffle 208, the first photoelectric sensor 209 detects a signal and controls the first push-rod motor 203 to stop, and the second push-rod motor 205 drives the vertical cutter 206 to move downward. At the same time, the fourth push-rod motor 210 drives the horizontal cutter 211 to move forward horizontally to cut off a small piece of two ends of the yam. The cutting length of the two ends of the yam is fixed. Upon completion of the cutting, the fourth push-rod motor 210 drives the horizontal cutter 211 to reset, the third push-rod motor 207 drives the baffle 208 to reset, and then the first push-rod motor 203 drives the vertical cutter 206 to push the yam to continuously move forward. The cut front end of the yam is pushed into the second yam end collection box 213, and then the yam is pushed into the feeding mechanism 40. When the yam is generally pushed into the feeding mechanism 40 about 10 cm, the first push-rod motor 203 drives the push plate 204 back. On the return trip, the vertical cutter 206 pulls a cut back end of the yam back and drops it into the first yam end collection box 212, the vertical cutter 206 is reset, and the support plate 217 is reset. When resetting of the support plate 217 is detected by the second photoelectric sensor 218, the stepping motor 2023 continues to rotate by 180 degrees. During rotation of the stepping motor, the pressing plate on the rotating semi-cylindrical panel separates from the horizontal end of the isolation plate, the isolation plate rises. At the same time, a delay of 3 seconds is generated, when the second photoelectric sensor detects that the support plate is reset, and the conveying mechanism continues to work repeatedly, achieving that another yam falls into the storage box and the above working process continues to be repeated.

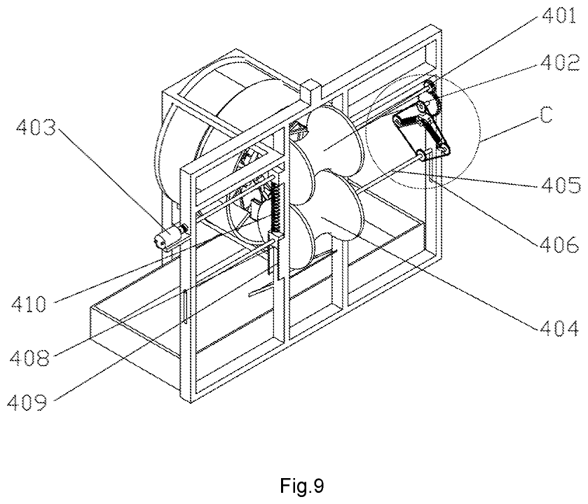

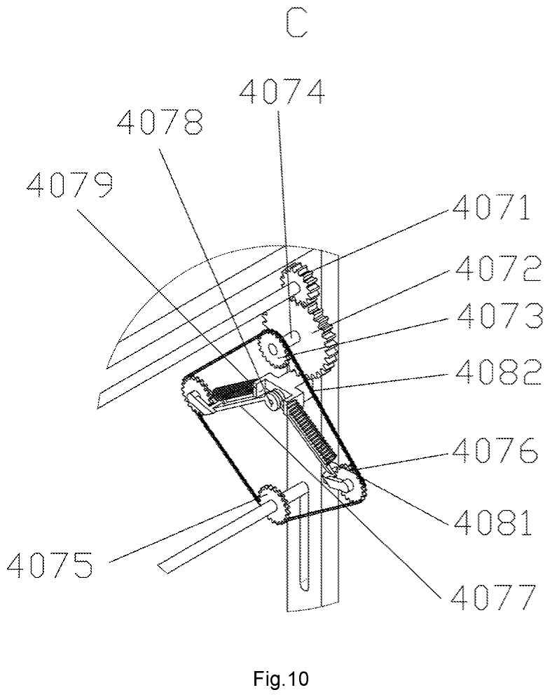

As shown in FIG. 9 and FIG. 10, the feeding mechanism 40 includes: a first rolling wheel 401 and a second plain shaft 402 fixedly connected to each other, the first rolling wheel 401 being sleeved on the second plain shaft 402, the second plain shaft 402 being rotatably connected to the rack 10, and one end of the second plain shaft 402 being connected to a feeding motor 403; a second rolling wheel 404 and a third plain shaft 405 fixedly connected to each other, the second rolling wheel 404 being sleeved on the third plain shaft 405, one end of the third plain shaft 405 being clamped in an plain shaft slot 406, the plain shaft slot 406 being arranged on the rack 10, and one end of the third plain shaft 405 clamped in the plain shaft slot 406 being connected to the other end of the second plain shaft 402 through a tensioning transmission mechanism 407; and a slider 408 sleeved on the third plain shaft 405, the slider 408 being clamped in a slider chute 409, the slider chute 409 being provided on the rack 10, a position of the slider chute 409 being in coordination with a position of the second roller 302, the slider 408 being vertically connected to the rack 10 through a first tension spring 410, and the second plain shaft 402 passing through a bump at a position where the first tension spring 410 is vertically connected to the rack 10, wherein the feeding motor 403 drives the first rolling wheel 401 and the second rolling wheel 404 to rotate in reverse directions simultaneously, and the tensioning transmission mechanism 407 includes: a first gear 4071 sleeved on the other end of the second plain shaft 402, the first gear 4071 being fixedly connected to the second plain shaft 402; a second gear 4072 and a third gear 4073 arranged in coordination, the second gear 4072 and the third gear 4073 being connected through a fourth plain shaft 4074 connected to the rack 10 through a bearing, and the second gear 4072 engaging with the first gear 4071; a fourth gear 4075 sleeved on one end of the third plain shaft 405, the fourth gear 4075 being fixedly connected to the third plain shaft 405; two fifth gears 4076 axisymmetric with respect to a connection line between the third gear 4073 and the fourth gear 4075, the third gear 4073, the fourth gear 4075, and the two fifth gears 4076 being connected through a chain 4082; two gear struts 4077, the two fifth gears 4076 being mounted to one end of the two gear struts 4077 through bearings respectively, and the other end of the two gear struts 4077 being connected to the rack 10 through a bidirectional bearing 4078; a strut slot 4079 provided in a middle-upper part of the bidirectional bearing 4078, the strut slot 4079 being fixedly connected to the rack 10 and used for limiting a rotation angle of the gear strut 4077; and two second tension springs 4081 with one end connected to one end of the two gear struts 4077 respectively, and the other end connected to an outer sidewall of the strut slot 4079. In this embodiment, the feeding motor 403 drives the first rolling wheel 401 and the second rolling wheel 404 to rotate in reverse directions at the same time, which improves the feeding efficiency. The tensioning transmission mechanism 407, the first tension spring 410, the slider 408, and so on can adjust the distance between the first rolling wheel 401 and the second rolling wheel 404, so as to adapt to feeding of yams with different thicknesses. The tensioning transmission mechanism 407 achieves tensioning and transmission through the coordination of gears, chains 4082, a second tension spring 4081, and so on, and has a limit on a maximum opening angle, which not only ensures the feeding of yams with different thicknesses, but also reduces the occurrence of yam slipping and other phenomena caused by a too large opening angle. After a yam is pushed into the feeding mechanism 40, the feeding mechanism 40 automatically adjusts a distance between the two rolling wheels according to the thicknesses of the yam. The feeding motor 403 drives the first rolling wheel 401 and the second rolling wheel 404 to rotate in reverse directions at the same time to gradually push the yam into the peeling and cleaning mechanism 50 for peeling and cleaning. Waste water slides into the waste water collection box 505 through the waste water chute 506. The yam is peeled and cleaned before being pushed out and may also be collected through a collection device or directly connected for the next processing of the yam.

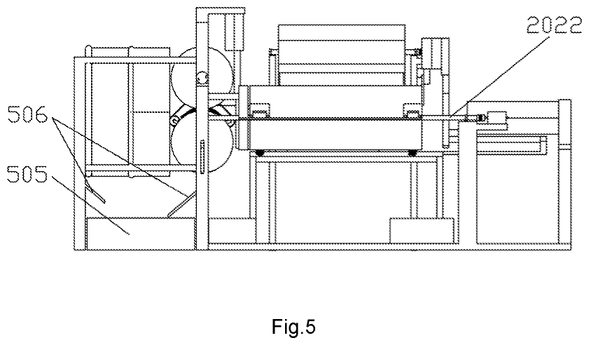

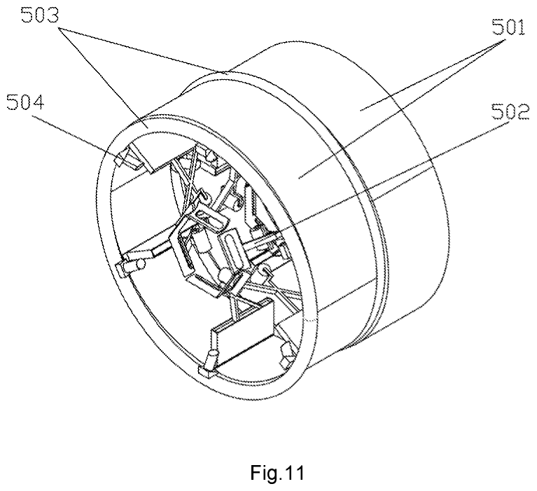

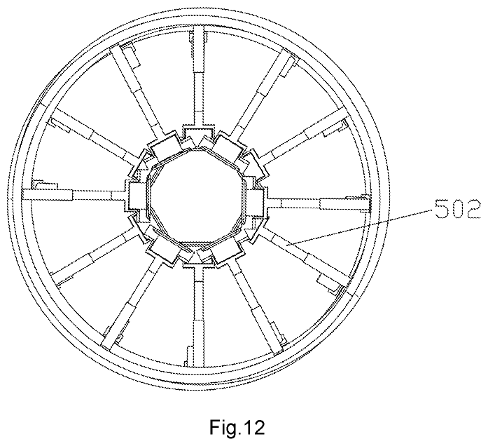

As shown in FIG. 5, FIG. 11 and FIG. 12, the peeling and cleaning mechanism 50 includes: a ring plate 501 fixed to the rack 10, an opening of the ring plate 501 being oriented toward the feeding mechanism 40; a peeling knife component 502 fixedly connected to the interior of the ring plate 501; an annular water pipe 503 arranged on a peripheral side of the ring plate 501, the annular water pipe 503 being connected to an external water supply device; a cleaning nozzle 504 connected to the annular water pipe 503, the cleaning nozzle 504 being oriented toward the peeling knife component 502; a waste water collection box 505 arranged below the ring plate 501, the waste water collection box 505 being detachably connected to the rack 10; and a waste water chute 506, the top of the waste water chute 506 being connected to the bottom of the ring plate 501, and the bottom of the waste water chute 506 being imported into the waste water collection box 505.

In this embodiment, the ring plate 501 supports the peeling knife component 502 and the annular water pipe 503. Peeled yams are cleaned through the cleaning nozzle 504. The water chute is conducive to the water slipping into the waste water collection box 505. Thus, peeling and cleaning operation of the yams are implemented.

The waste water collection box 505 may be further provided with a sewage outlet to discharge waste water.

Preferably, there are two ring plates 501 connected to each other, a plurality of peeling knife components 502 are annularly arrayed in each of the ring plates 501, and positions of the peeling knife components 502 in the two ring plates 501 are staggered.

In this embodiment, two ring plates 501 connected to each other are arranged, a plurality of peeling knife components 502 are annularly arrayed in each of the ring plates 501, and positions of the peeling knife components 502 in the two ring plates 501 are staggered, so that the peeling of the yams is more comprehensive, cleaner, and more efficient.

As shown in FIG. 11 to 13, 6 peeling knife components 502 are arranged in each of the ring plates 501, the peeling knife components 502 are annularly arrayed in the ring plates 501, included angles formed by every two adjacent peeling knife components 502 are the same in front projections of the 12 peeling knife components 502 in the two ring plates 501. The peeling knife component 502 includes: spring boxes 5021 vertically fixed and connected to the ring plate 501, and three springs being uniformly arranged in each of the spring boxes 5021; a spring pressing plate 5022 embedded in a port of the spring box 5021 toward the center of the ring plate 501; a peeling knife support rod 5023 fixedly connected to the spring pressing plate 5022; and a peeling knife 5024 and a limit rolling wheel 5025 mounted on the peeling knife support rod 5023, a distance between the limit rolling wheel 5025 and the spring box 5021 being less than a distance between the peeling knife 5024 and the spring box 5021, the peeling knife 5024 and the limit rolling wheel 5025 being arranged in front and back and adjacent to each other, and when the yam is pushed in, the yam first passing through the limit rolling wheel 5025 and then passing through the peeling knife 5024.

In this embodiment, the peeling knife 5024, the limit rolling wheel 5025, and so on are arranged to implement the peeling of yams, which also effectively guarantees that the peeling would not be too thick due to too much downward pressure of the spring, thereby reducing waste and saving costs to some extent.

It should be noted that the spring pressing plate 5022 moves back and forth while pressing the spring, and cannot slide out of the spring box 5021. A peeling thickness can be controlled by adjusting a height difference between the limit rolling wheel 5025 and the spring box 5021.

As shown in FIG. 11 and FIG. 12, the cleaning nozzle 504 one-to-one corresponds to the peeling knife component 502.

In this embodiment, the one-to-one correspondence between the cleaning nozzle 504 and the peeling knife component 502 further improves the cleaning efficiency and cleanliness.

As shown in FIG. 1 and FIG. 2, the conveying mechanism 30 includes: a conveying motor 301 and rollers 302 arranged in coordination, fixedly connected to the rack 10, the two rollers 302 being arranged at intervals, and the conveying motor 301 being connected to one of the rollers 302; a conveyor belt 303 sleeved on the roller 302, the conveying motor 301 driving the roller 302 to rotate, so as to drive the conveyor belt 303 for transmission, and the conveyor belt 303 being arranged in coordination with the storage box 201 to convey the yam into the storage box 201; a plurality of partitions 304 arranged at intervals on the conveyor belt 303; and a third photoelectric sensor 305 arranged on a lower side of the roller 302 adjacent to the storage box 201, the third photoelectric sensor 305 being oriented toward a bottom part of the conveyor belt 303, and a vertical distance between the third photoelectric sensor 305 and the lowest surface of the conveyor belt 303 being lower than the height of the partitions 304.

In this embodiment, the conveying motor 301, the roller 302, the conveyor belt 303, the plurality of partitions 304, the third photoelectric sensor 305, and so on are arranged in coordination to implement automatic conveying of yams, which controls that one yam is conveyed into the storage box 201 of the two-end removing mechanism 20 at a time, is conducive to two-end removal, peeling, cleaning, and other operations on the yams, and has a high automation degree of conveying and high conveying efficiency.

Specifically, a single yam is placed between two adjacent partitions 304, and the third photoelectric sensor 305 controls a conveying distance of the conveyor by detecting the partitions 304 on the conveyor belt 303. When the third photoelectric sensor 305 detects a signal, it controls the stop of the conveyor belt 303 upon a delay of 1 second, thus controlling forward conveying of one yam at a time. The conveyor belt 303 is tilted to ensure that the yam slips into the storage box 201. Herein, controlling the conveyor belt 303 to stop upon a delay of 1 second can effectively reduce the occurrence of self-locking of the third photoelectric sensor 305 and the second photoelectric sensor 218.

The working process of the automatic all-in-one machine for clearing, peeling, and cleaning yam is as follows:

a single yam is placed between two adjacent partitions 304, and the third photoelectric sensor 305 controls a conveying distance of the conveyor by detecting the partitions 304 on the conveyor belt 303. When the third photoelectric sensor 305 detects a signal, it controls the stop of the conveyor belt 303 upon a delay of 1 second, thus controlling forward conveying of one yam at a time. The conveyor belt 303 is tilted to ensure that the yam slips into the storage box 201. The working process of the two-end removing mechanism 20 is as follows: the stepping motor 2023 drives the rotating semi-cylindrical panel 2021 to rotate clockwise. With the rotation of the rotating semi-cylindrical panel 2021, the pressing plate 2024 on the rotating semi-cylindrical panel 2021 comes into contact with a horizontal end of the isolation plate 214. With the continuous rotation of the rotating semi-cylindrical panel 2021, the isolation plate 214 moves down, and the yam in the storage box 201 slides into the rotating semi-cylindrical panel 2021. When the isolation plate 214 is lower than the storage box 201, the stepper motor stops, that is, the stepper motor stops after rotating by 180 degrees clockwise. In this case, the push plate 204 and the baffle 208 are both tangent to the rotating semi-cylindrical panel 2021. Then, the first push-rod motor 203 drives the push plate 204 to move forward. The push plate 204 drives the yam inside the rotating semi-cylindrical panel 2021 to move forward, and at the same time drives the support plate 217 to move forward to provide support at the bottom of the rotating semi-cylindrical panel 2021, so as to prevent the rotating semi-cylindrical panel 2021 from being pressed when the vertical cutter 206 cuts downward. When a front end of the yam hits the baffle 208, the first photoelectric sensor 209 detects a signal and controls the first push-rod motor 203 to stop, and the second push-rod motor 205 drives the vertical cutter 206 to move downward. At the same time, the fourth push-rod motor 210 drives the horizontal cutter 211 to move forward horizontally to cut off a small piece of two ends of the yam. The cutting length of the two ends of the yam is fixed. Upon completion of the cutting, the fourth push-rod motor 210 drives the horizontal cutter 211 to reset, the third push-rod motor 207 drives the baffle 208 to reset, and then the first push-rod motor 203 drives the vertical cutter 206 to push the yam to continuously move forward. The cut front end of the yam is pushed into the second yam end collection box 213, and then the yam is pushed into the feeding mechanism 40. When the yam is generally pushed into the feeding mechanism 40 about 10 cm, the first push-rod motor 203 drives the push plate 204 back. On the return trip, the vertical cutter 206 pulls a cut back end of the yam back and drops it into the first yam end collection box 212, the vertical cutter 206 is reset, and the support plate 217 is reset. When resetting of the support plate 217 is detected by the second photoelectric sensor 218, the stepping motor 2023 continues to rotate by 180 degrees. During rotation of the stepping motor 2023, the isolation plate 214 is bounced, and the second photoelectric sensor 218 detects a delay of 3 seconds when the support plate 217 is reset. The conveying mechanism 30 continues to work repeatedly, achieving that another yam falls into the storage box 201 and the above working process continues to be repeated. After a yam is pushed into the feeding mechanism 40, the feeding mechanism 40 automatically adjusts a distance between the two rolling wheels according to the thicknesses of the yam. The feeding motor 403 drives the first rolling wheel 401 and the second rolling wheel 404 to rotate in reverse directions at the same time to gradually push the yam into the peeling and cleaning mechanism 50 for peeling and cleaning. Waste water slides into the waste water collection box 505 through the waste water chute 506. The yam is peeled and cleaned before being pushed out and may also be collected through a collection device or directly connected for the next processing of the yam.

The technical solutions of the present invention is explained in detail in combination with the attached drawing above, and the present invention provides an automatic all-in-one machine for cleaning, peeling and cleaning yams. In this solution, the two-end removing mechanism, the conveying mechanism, the feeding mechanism, the peeling and cleaning mechanism, the controller, and so on are arranged to perform automatic two-end removal, peeling, cleaning, and other operations on yams with different thicknesses and lengths. Through ingenious coordination between the stepping motor, the photoelectric sensors, and so on, the yams slip out one by one. Two ends of the yams with different lengths can be removed through the coordination of the photoelectric sensors, the push-rod motor, and the cutter. The tensioning transmission mechanism arranged in the feeding mechanism can achieve that a motor drives two rolling wheels to rotate in reverse directions simultaneously, and can achieve a change in the distance between the two rolling wheels according to yams with different thicknesses, so as to feed the yams with different thicknesses. The peeling knife and the limit rolling wheel are arranged in coordination to control the thickness of peeling, which reduces waste to some extent and makes peeled cleaning clearer and the quality of the yams after treatment better.

In the present invention, the terms “first,” “second,” and “third” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

In the description of the specification, the descriptions about the terms “an embodiment,” “some embodiments,” “specific embodiment(s),” and the like mean that specific features, structures, materials or characteristics described in combination with the embodiment(s) or example(s) are included in at least one embodiment or example of the present invention. In the specification, schematic expressions of the above terms do not necessarily refer to the same embodiment or example. Moreover, the specific features, structures, materials or characteristics described may be combined in a suitable manner in any one or more embodiments or examples.

The above are merely preferred embodiments of the present invention and are not intended to limit the present invention. The present invention may be subject to changes and variations for those skilled in the art. Any modifications, equivalent replacements, and improvements made within the spirit and principles of the present invention shall all be encompassed in the protection scope of the present invention.

What is claimed is:

1. An automatic all-in-one machine for clearing, peeling, and cleaning yams, comprising:
a rack;
a two-end removing mechanism arranged on the rack, the two-end removing mechanism comprising:
a storage box;
an accommodating portion arranged adjacent to and in coordination with the storage box, a curved surface side of the accommodating portion being adjacent to the bottom of the storage box for accommodating the yams;
a first push-rod motor and a push plate connected to and coordinated with each other, arranged on one semicircular opening side of the accommodating portion away from the feeding mechanism, the first push-rod motor being fixedly connected to the rack;
a second push-rod motor and a vertical cutter connected to and coordinated with each other, arranged on one side of the push plate toward the accommodating portion, the vertical cutter being driven by the second push-rod motor to move up and down along a vertical direction to cut one end of the yam;
a third push-rod motor and a baffle connected to and coordinated with each other, arranged on the other semicircular opening side of the accommodating portion adjacent to the feeding mechanism, the third push-rod motor being fixedly connected to the rack, and a first photoelectric sensor facing down being arranged in the top middle of the baffle;
a fourth push-rod motor and a horizontal cutter connected to and coordinated with each other, arranged adjacent to the other semicircular opening side of the accommodating portion, the fourth push-rod motor being fixedly connected to the rack, the fourth push-rod motor pushing the horizontal cutter to move back and forth in a horizontal direction to cut away the other end of the yam, and the accommodating portion being provided with a cutter groove matching the horizontal cutter;
a conveying mechanism arranged on the rack, the conveying mechanism being arranged adjacent to and in coordination with the storage box and being used for conveying a yam into the storage box;
the conveying mechanism comprising: a conveying motor and rollers arranged in coordination, fixedly connected to the rack, the two rollers being arranged at intervals, and the conveying motor being connected to one of the rollers; a conveyor belt sleeved on the roller, the conveying motor driving the roller to rotate, so as to drive the conveyor belt for transmission, and the conveyor belt being arranged in coordination with the storage box to convey the yam into the storage box;
a feeding mechanism arranged on the rack, an input end of the feeding mechanism being coordinated with and connected to an output end of the two-end removing mechanism, and the feeding mechanism being used for pushing the yams after two-end removal through the two-end removing mechanism;
a peeling and cleaning mechanism arranged on the rack, the peeling and cleaning mechanism being arranged in coordination with and adjacent to the feeding mechanism and being used for peeling and cleaning the yam pushed by the feeding mechanism;
the peeling and cleaning mechanism comprising:
a ring plate fixed to the rack, an opening of the ring plate being oriented toward the feeding mechanism;
a peeling knife component fixedly connected to the interior of the ring plate;
an annular water pipe arranged on a peripheral side of the ring plate, the annular water pipe being connected to an external water supply device;
a cleaning nozzle connected to the annular water pipe, the cleaning nozzle being oriented toward the peeling knife component; a waste water collection box arranged below the ring plate, the waste water collection box being detachably connected to the rack; and
a waste water chute, the top of the waste water chute being connected to the bottom of the ring plate, and the bottom of the waste water chute being imported into the waste water collection box; and
a controller connected to the two-end removing mechanism, the conveying mechanism, the feeding mechanism, and the peeling and cleaning mechanism respectively.

2. The automatic all-in-one machine for clearing, peeling, and cleaning yams according to claim 1, wherein the two-end removing mechanism further comprises:
a first yam end collection box arranged below a gap between the push plate and the semicircular opening side, the first yam end collection box being detachably connected to the rack; and
a second yam end collection box arranged below a gap between the push plate and the semicircular opening side, the second yam end collection box being detachably connected to the rack.

3. The automatic all-in-one machine for clearing, peeling, and cleaning yams according to claim 2, wherein the accommodating portion comprises:
two rotating semi-cylindrical panels welded opposite to each other on a first plain shaft, the first plain shaft being rotatably connected to the rack;
a stepping motor connected to the first plain shaft, the stepping motor driving the first plain shaft to rotate to drive the rotating semi-cylindrical panels to rotate, and the stepping motor being fixedly connected to the rack; and
a pressing plate fixedly connected to two edges of the two rotating semi-cylindrical panels opposite to the conveying mechanism; and
the two-end removing mechanism comprises:
an isolation plate arranged between the storage box and the accommodating portion, a horizontal end of the isolation plate being sleeved on a spring loop bar fixedly connected to the rack, a spring being sleeved on the spring loop bar, and a top end of the spring being in contact with the isolation plate; and
a bottom surface of the storage box tilting downwards.

4. The automatic all-in-one machine for clearing, peeling, and cleaning yams according to claim 3, wherein the two-end removing mechanism further comprises:
a support plate fixedly connected to a lower part of the push plate, the support plate being perpendicular to the push plate and extending toward the accommodating portion along the horizontal direction, a height of an extension section of the support plate from the push plate to the accommodating portion being lower than a bottom surface of the accommodating portion, and a horizontal length of the extension section being greater than a horizontal distance from the vertical cutter to the push plate; and
a second photoelectric sensor fixedly connected to the rack and oriented toward the support plate.

5. The automatic all-in-one machine for clearing, peeling, and cleaning yams according to claim 1, wherein the feeding mechanism comprises:
a first rolling wheel and a second plain shaft fixedly connected to each other, the first rolling wheel being sleeved on the second plain shaft, the second plain shaft being rotatably connected to the rack, and one end of the second plain shaft being connected to a feeding motor;
a second rolling wheel and a third plain shaft fixedly connected to each other, the second rolling wheel being sleeved on the third plain shaft, one end of the third plain shaft being clamped in an plain shaft slot, the plain shaft slot being arranged on the rack, and one end of the third plain shaft clamped in the plain shaft slot being connected to the other end of the second plain shaft through a tensioning transmission mechanism; and
a slider sleeved on the third plain shaft, the slider being clamped in a slider chute, the slider chute being provided on the rack, a position of the slider chute being in coordination with a position of the second roller, the slider being vertically connected to the rack through a first tension spring, and the second plain shaft passing through a bump at a position where the first tension spring is vertically connected to the rack,
wherein the feeding motor drives the first rolling wheel and the second rolling wheel to rotate in reverse directions simultaneously, and
the tensioning transmission mechanism comprises:
a first gear sleeved on the other end of the second plain shaft, the first gear being fixedly connected to the second plain shaft;
a second gear and a third gear arranged in coordination, the second gear and the third gear being connected through a fourth plain shaft connected to the rack through a bearing, and the second gear engaging with the first gear;
a fourth gear sleeved on one end of the third plain shaft, the fourth gear being fixedly connected to the third plain shaft;
two fifth gears axisymmetric with respect to a connection line between the third gear and the fourth gear, the third gear, the fourth gear, and the two fifth gears being connected through a chain;
two gear struts, the two fifth gears being mounted to one end of the two gear struts through bearings respectively, and the other end of the two gear struts being connected to the rack through a bidirectional bearing;
a strut slot provided in a middle-upper part of the bidirectional bearing, the strut slot being fixedly connected to the rack and used for limiting a rotation angle of the gear strut; and
two second tension springs with one end connected to one end of the two gear struts respectively, and the other end connected to an outer sidewall of the strut slot.

6. The automatic all-in-one machine for clearing, peeling, and cleaning yams according to claim 1, wherein
there are two ring plates connected to each other, a plurality of peeling knife components are annularly arrayed in each of the ring plates, and positions of the peeling knife components in the two ring plates are staggered.

7. The automatic all-in-one machine for clearing, peeling, and cleaning yams according to claim 6, wherein 6 peeling knife components are arranged in each of the ring plates, the peeling knife components are annularly arrayed in the ring plates, every two adjacent peeling knife components are at the same included angle in front projections of the 12 peeling knife components in the two ring plates, and
the peeling knife component comprises:
spring boxes vertically fixed and connected to the ring plate, and three springs being uniformly arranged in each of the spring boxes;
a spring pressing plate embedded in a port of the spring box toward the center of the ring plate;
a peeling knife support rod fixedly connected to the spring pressing plate;
a peeling knife mounted on the peeling knife support rod; and
a limit rolling wheel mounted on the peeling knife support rod, a distance between the limit rolling wheel and the spring box being less than a distance between the peeling knife and the spring box, the peeling knife and the limit rolling wheel being arranged in front and back and adjacent to each other, and when the yam is pushed in, the yam first passing through the limit rolling wheel and then passing through the peeling knife.

8. The automatic all-in-one machine for clearing, peeling, and cleaning yams according to claim 7, wherein the cleaning nozzle one-to-one corresponds to the peeling knife component.

9. The automatic all-in-one machine for clearing, peeling, and cleaning yams according to claim 1, wherein the conveying mechanism comprises:
a plurality of partitions arranged at intervals on the conveyor belt; and
a third photoelectric sensor arranged on a lower side of the roller adjacent to the storage box, the third photoelectric sensor being oriented toward a bottom part of the conveyor belt, and a vertical distance between the third photoelectric sensor and the lowest surface of the conveyor belt being lower than the height of the partitions.
